(19) United States
(12) Patent Application Publication
(10) Pub. No.: US 2005/0197413 A1
(43) Pub. Date: Sep. 8, 2005

(54) Flexible molded parts of expanded polyurethane and their use

(76) Inventors: Wolfgang Grimm, Leverkusen (DE); Erhard Michels, Koln (DE); Klaus Brecht, Burscheid (DE); Uwe Pfeuffer, Leverkusen (DE)

Correspondence Address: BAYER MATERIAL SCIENCE LLC, 100 BAYER ROAD, PITTSBURGH, PA, 15205, US

(21) Appl. No.: 11/069,241

(22) Filed: Mar. 1, 2005

(30) Foreign Application Priority Data
Mar. 5, 2004 (DE) 1020040108099

(51) Int. Cl. C08J 9/00

(52) U.S. Cl. 521/50

(57) ABSTRACT

The invention relates to flexible molded parts of expanded polyurethane with molded part densities of <350 kg/m³ and with a thick skin on one side and good molded part stability (molded part shrinkage <1.5%; according to DIN ISO 02769) based on special components, and their use, especially in the shoe sector.

### BACKGROUND OF THE INVENTION

The present invention relates to flexible molded parts of expanded polyurethane in which the molded parts have average densities of <350 kg/m³ and which have an unilaterally compact skin on one side, and that exhibit good molded part stability (i.e. the molded part shrinkage is <1.5%; according to DIN ISO 02769). The present invention also relates to a process for the production of these flexible molded parts, and to their use, particularly in the shoe sector.

Processes for the production of flexible microcellular elastomers of low density are described in EP-A 1 225 199. In these processes, CO₂ is used as blowing agent, and it is dissolved in the isocyanate and/or polyol components. The mixture is then expanded. The disadvantage of this technology is that, on account of the low molded part densities (generally <300 kg/m³), only a thin, non-wear-resistant skin is formed.

### SUMMARY OF THE INVENTION

The object of the present invention was to provide a process suitable for the production of molded parts of low densities and high wear resistance.

This object has been achieved by the process according to the invention and by the molded parts according to the invention. The wear resistance is in this connection achieved by means of a thick skin that is unilaterally formed on the side of the molded part of integral structure exposed to wear.

The present invention relates to flexible molded parts of expanded polyurethane in which the molded parts have average densities of <350 kg/m³, preferably <300 kg/m³, and have an unilaterally compacted edge zone (skin) with a thickness of 0.5 mm to 3 mm, preferably 0.7 mm to 2.5 mm, which has an average density of >650 kg/m³, and enclosed hollow microspheres, with a molded part shrinkage of <1.5% (according to DIN ISO 02769). These flexible molded parts comprise the reaction product of:
a) one or more organic polyisocyanates with 2 to 4 NCO groups per molecule and an NCO content of 6 to 49 wt. %;
b) a polyol component selected from the group consisting of:
   b1) one or more polyether ester polyols with a number average molecular weight of 800 g/mole to 6,000 g/mole, preferably 1,200 g/mole to 4,000 g/mole, an average functionality of 1.7 to 4, preferably 1.8 to 2.7, and a weight ratio of ether groups to ester groups of the polyether ester polyol of 5:95 to 48:52, preferably of 8:92 to 30:70, wherein the polyether ester polyols are prepared by polycondensation of:
      b1.1) one or more dicarboxylic acids with up to 12 carbon atoms and/or their derivatives,
      b1.2) one or more polyether polyol components selected from the group consisting of
         (i) one or more polyether polyols with a number average molecular weight of 1,000 g/mole to 8,000 g/mole, preferably 1,500 g/mole to 6,000 g/mole, an ethylene oxide content of 10 to 40 wt. %, preferably 15 to 35 wt. %, more preferably 18 to 32 wt. %, and
         (ii) one or more ether-based polymer polyols with OH numbers of 10 to 149 and average functionalities of 1.7 to 4, preferably 1.8 to 3.5, and which contain 1 to 50 wt. %, preferably 1 to 45 wt. % of solids, based on the total weight of polymer polyol,
      b1.3) one or more polyols with a number average molecular weight of 62 to 750 g/mole, preferably 62 g/mole to 400 g/mole, more preferably 62 g/mole to 200 g/mole, an average functionality of 2 to 8, and containing at least two terminal OH groups per molecule,
      and, optionally,
      b1.4) one or more ester-based polymer polyols having OH numbers of 10 to 149, and average functionalities of 1.7 to 4, preferably 1.8 to 3.5, and which contain 1 to 50 wt. %, preferably 1 to 45 wt. % of solids, based on the total weight of polymer polyol,
   b2) a mixture of
      b2.1) 52 to 95 wt. %, preferably 70 to 92 wt. %, based on 100 wt. % of b2), of one or more polyester polyol components selected from the group consisting of:
         (i) one or more polyester polyols with a number average molecular weight of 1,000 to 4,000 g/mole and an average functionality of 1.7 to 4 and
         (ii) one or more ester-based polymer polyols with OH numbers of 10 to 149 and average functionalities of 1.7 to 4, preferably 1.8 to 3.5, and which contain 1 to 50 wt. %, preferably 1 to 45 wt. % of solids, based on the total weight of polymer polyol,
      b2.2) 5 to 48 wt. %, preferably 8 to 30 wt. %, based on 100 wt. % of b2), of one or more polyether polyol components selected from the group consisting of:
         (i) one or more polyether polyols containing ethylene oxide groups, having a number average molecular weight of 900 to 18,000 g/mole, preferably 2,000 to 8,000 g/mole, an average functionality of 1.7 to 4, preferably 1.8 to 2.7, and an ethylene oxide content of 10 to 40 wt. %, preferably 15 to 35 wt. %, and more preferably 18 to 32 wt. %, and
         (ii) one or more ether-based polymer polyols having OH numbers of 10 to 149 and average functionalities of 1.7 to 4, preferably 1.8 to 3.5, and which contain 1 to 50 wt. %, preferably 1 to 45 wt. % of solids, based on the total weight of polymer polyol,
   b3) one or more polyether polyol components with an average hydroxyl functionality of 2.02 to 2.95, and being selected from the group consisting of:
      b3.1) at least one polyether diol with a hydroxyl number of 10 to 115 and which comprises the reaction product prepared by propoxylation of a difunctional starter, with subsequent ethoxylation of the propoxylation product, while maintaining a weight ratio of propylene oxide to ethylene oxide of 60:40 to 85:15, and
      b3.2) at least one polyether triol that optionally contains solids based on styrene/acrylonitrile copolymers, polyureas or polyhydrazocarbonamides in an amount of up to 20 wt. %, based on the total weight of component b3), with a hydroxyl number of 12 to 56, and which comprises the reaction product prepared by propoxylation of a trifunctional starter, with subsequent ethoxylation of the propoxylation product, while maintaining a weight ratio of propylene oxide to ethylene oxide of 60:40 to 85:15,
   b4) one or more polyester polyol components which optionally contains 1 to 50 wt. %, preferably 1 to 45 wt. % of solids, based on the total weight of b4), and being selected from the group consisting of:
      (i) one or more polyester polyols with a number average molecular weight of 1,000 to 4,000 g/mole and an average functionality of 1.7 to 4 and
      ii) one or more ester-based polymer polyols with OH numbers of 10 to 149, and average functionalities of 1.7 to 4, preferably 1.8 to 3.5, and that contain from 1 to 50 wt. % of solids, based on the total weight of b4),
   b5) a mixture of b1) and b2),
   b6) a mixture of b1) and b3) and
   b7) a mixture of b1) and b4);
c) 5 to 25 wt. %, based on the weight of components b) and c), of one or more crosslinking agents and/or chain extenders,
d) a blowing agent component comprising:
   d1) at least one blowing agent selected from the group consisting of nitrogen, air and carbon dioxide,
   d2) at least one component selected from the group consisting chemical blowing agents and physical blowing agents with boiling points in the range from −30° C. to 75° C., and
   d3) one or more physically expanding hollow microspheres, and, optionally, one or more of
e) one or more emulsifiers,
f) one or more additives and auxiliary substances,
g) one or more catalysts,
   wherein the Isocyanate Index is from 95 to 115.

In accordance with the present invention, it is preferred that the component used as d1) is added to the polyol component b) and/or to the polyisocyanate component a). The blowing agent used as component d2) is preferably added to the polyol component b). The blowing agent used as component d3) may either be metered in separately or added to the polyol component b).

The present invention also provides a process for the production of the flexible molded parts according to the invention from expanded polyurethane in which the molded parts have average densities of <350 kg/m³, preferably <300 kg/m³, and have an unilaterally compacted edge zone (skin) having a thickness of 0.5 to 3 mm, preferably 0.7 to 2.5 mm, in which the edge zone has an average density of >650 kg/m³ and contains enclosed hollow microspheres. These molded parts have a part shrinkage of <1.5% (according to DIN ISO 02769). This process comprises
A) reacting component a), the polyisocyanate, with component b), the polyol component, and component c), the crosslinking agents and/or chain extenders, with the addition of component d), and optionally with components e) and/or f), in the presence of component g), in a mold, at an Isocyanate Index of 95 to 115, and
B) removing the resultant molded part from the mold.

### DETAILED DESCRIPTION OF THE INVENTION

As used in the present invention, the term Isocyanate Index denotes the molar ratio of the NCO groups of the polyisocyanate component that is used to the NCO-reactive terminal groups of the components b), c) and d), multiplied by 100. An Isocyanate Index of 100 corresponds to a stoichiometric amount of isocyanate groups to NCO-reactive terminal groups.

Also, as used herein, the term OH number (or hydroxyl number) denotes the molecular weight of KOH multiplied by 1,000 and by the functionality of the polyol, divided by the molecular weight of the polyol.

Suitable polyisocyanates to be used as component a) for the molded parts according to the present invention are aliphatic, cycloaliphatic, araliphatic, aromatic and heterocyclic polyisocyanates, as are described by, for example, W. Siefken in Justus Liebigs Annalen der Chemie, 562, pages 75 to 136. These polyisocyanates include, for example, those which correspond to the formula:
Q(NCO)ₙ
in which
   n=2-4, preferably 2, and
   Q represents an aliphatic hydrocarbon radical with 2 to 18 and preferably 6 to 10 carbon atoms, a cycloaliphatic hydrocarbon radical with 4 to 15 and preferably 5 to 10 carbon atoms, an aromatic hydrocarbon radical with 6 to 15 and preferably 6 to 13 carbon atoms, or an araliphatic hydrocarbon radical with 8 to 15 and preferably 8 to 13 carbon atoms.

Suitable polyisocyanates include, for example, ethylene diisocyanate, 1,4-tetramethylene diisocyanate, 1,6-hexamethylene diisocyanate (HDI), 1,12-dodecane diisocyanate, cyclobutane-1,3-diisocyanate, cyclohexane-1,3 diisocyanate and cyclohexane-1,4 diisocyanate as well as arbitrary mixtures of these isomers, 1-isocyanato-3,3,5-trimethyl-5-isocyanatomethylcyclohexane, 2,4-hexahydrotoluylene diisocyanate and 2,6-hexahydrotoluylene diisocyanate as well as arbitrary mixtures of these isomers, hexahydro-1,3-phenylene diisocyanate and hexahydro-1,4-phenylene diisocyanate, perhydro-2,4′-diphenylmethane diisocyanate and perhydro-4,4′-diphenylmethane diisocyanate, 1,3-phenylene diisocyanate and 1,4-phenylene diisocyanate, 1,4-durol diisocyanate (DDI), 4,4′-stilbene diisocyanate, 3,3′-dimethyl-4,4′-biphenylene diisocyanate (TODI), 2,4′-toluylene diisocyanate and 2,6′-toluylene diisocyanate (TDI), as well as arbitrary mixtures of these isomers, diphenylmethane-2,4′-diisocyanate and/or diphenylmethane-4,4′-diisocyanate (MDI), or naphthylene-1,5 diisocyanate (NDI). Also suitable polyisocyanate include, for example, the following: triphenylmethane-4,4′,4″-triisocyanate, polyphenylpolymethylene polyisocyanates as are obtained by aniline/formaldehyde condensation and subsequent phosgenation and as described in, for example, GB-PS 874 430 and GB-PS 848 671, the disclosures of which are hereby incorporated by reference, m-isocyanatophenylsulfonyl isocyanate and p-isocyanatophenylsulfonyl isocyanate as described in, for example, U.S. Pat. No. 3,454,606, the disclosure of which is hereby incorporated by reference, perchlorinated aryl polyisocyanates such as are described in, for example, U.S. Pat. No. 3,277,138, the disclosure of which is hereby incorporated by reference, polyisocyanates containing carbodiimide groups, as are described in, for example, U.S. Pat. No. 3,152,162, the disclosure of which is hereby incorporated by reference, as well as in DE-OS 25 04 400, 25 37 685 and 25 52 350, the disclosures of which are hereby incorporated by reference, norbornane diisocyanates as described in U.S. Pat. No. 3,492,301, the disclosure of which is hereby incorporated by reference, polyisocyanates containing allophanate groups, as are described in GB-PS 994 890, in BE-PS 761 626 and NL-A 7 102 524, the disclosures of which are hereby incorporated by reference, polyisocyanates containing isocyanurate groups, as are described in U.S. Pat. No. 3,001,9731 the disclosure of which is hereby incorporated by reference, and in DE-PS 10 22 789, 12 22 067 and 1 027 394 as well as in DE-OS 1 929 034 and 2 004 048, the disclosures of which are hereby incorporated by reference, polyisocyanates containing urethane groups, as are described in, for example, BE-PS 752 261 or in U.S. Pat. Nos. 3,394,164 and 3,644,457, the disclosures of which are hereby incorporated by reference, polyisocyanates containing acylated urea groups as described in, for example, to DE-PS 1 230 778, the disclosure of which is hereby incorporated by reference, polyisocyanates containing biuret groups, as are described in, for example, U.S. Pat. Nos. 3,124,605, 3,201,372 and 3,124,605, the disclosures of are hereby incorporated by reference, as well as in GB-PS 889,050, polyisocyanates produced by telomerisation reactions, as are described in, for example, U.S. Pat. No. 3,654,106, the disclosure of which is hereby incorporated by reference, polyisocyanates containing ester groups, as are described in, for example, GB-PS 965 474 and 1 072 956, the disclosures of which are hereby incorporated by reference, and in U.S. Pat. No. 3,567,763, the disclosure of which is hereby incorporated by reference, and in DE-PS 12 31 688, the disclosure of which is hereby incorporated by reference, reaction products of the aforementioned isocyanates with acetals according to DE-PS 1 072 385, the disclosure of which is hereby incorporated by reference, and polyisocyanates containing polymeric fatty acid esters as described in, U.S. Pat. No. 3,455,883, the disclosure of which is hereby incorporated by reference.

It is also possible to use the distillation residues occurring in industrial isocyanate production and containing isocyanate groups, optionally dissolved in one or more of the aforementioned polyisocyanates. In addition, it is possible to employ arbitrary mixtures of the aforementioned polyisocyanates.

The industrially readily accessible polyisocyanates are preferably used such as, for example, 2,4-toluylene diisocyanate and 2,6-toluylene diisocyanate, as well as arbitrary mixtures of these isomers (“TDI”), 4,4′-diphenylmethane diisocyanate, 2,4′-diphenylmethane diisocyanate, 2,2′-diphenylmethane diisocyanate and polyphenyl/polymethylene polyisocyanates, such as are produced by aniline/formaldehyde condensation and subsequent phosgenation (“crude MDI”), and polyisocyanates containing carbodiimide groups, uretonimine groups, urethane groups, allophanate groups, isocyanurate groups, urea groups or biuret groups (“i.e. modified polyisocyanates”), and in particular those modified polyisocyanates that are derived from 2,4-toluylene diisocyanate and/or 2,6-toluylene diisocyanate, or from 4,4′-diphenylmethane diisocyanate and/or 2,4′-diphenylmethane diisocyanate. Naphthylene-1,5-diisocyanate and mixtures of the aforementioned polyisocyanates are also very suitable.

It is, however, particularly preferred in the process according to the invention to use prepolymers containing isocyanate groups that are produced by reacting at least a partial amount of polyol component b1), b2.1), b2.2), or a mixture thereof, and/or chain extenders and/or crosslinking agents c), with at least one aromatic diisocyanate from the group TDI, MDI, TODI, DIBDI, NDI, DDI, and preferably with 4,4′-MDI and/or 2,4-TDI and/or 1,5-NDI to form a polyaddition product containing urethane groups and isocyanate groups which has an NCO group content of 6 to 35 wt. %, preferably 10 to 25 wt. %.

The prepolymers containing isocyanate groups may be produced in the presence of catalysts. It is, however, also possible to produce the prepolymers containing isocyanate groups in the absence of catalysts, and to incorporate the latter in the reaction mixture only for the production of the PUR elastomers. In order to alter the viscosity and achieve higher gas uptake, non-reactive additives, low molecular weight esters such as phthalates, adipates, but also ring esters, cyclic carbonates and terminally blocked polyethers may also be added to the prepolymer.

The term “polyether ester polyol” as used herein is understood to denote a compound that contains ether groups, ester groups and OH groups. In accordance with present invention, the polyol component b) comprises b1) one or more polyether ester polyols as described in detail below; b2) a mixture of b2.1) one or more polyester polyol components, and b2.2) one or more polyether polyol components as described below; b3) one or more polyether polyol components as described below; b4) one or more polyester polyol components as described below; b5) a mixture of b1) and b2); b6) a mixture of b1) and b3); and b7) a mixture of b1) and b4).

Suitable polyether ester polyols to be used as the polyether ester polyols b1) in accordance with the present invention have a number average molecular weight of 800 g/mole to 6,000 g/mole, preferably 1,200 g/mole to 4,000 g/mole, a number average hydroxyl functionality of 1.7 to 4, preferably 1.8 to 2.7, and a weight ratio of ether groups to ester groups of 5:95 to 48:52, and more preferably of 8:92 to 30:70. Such polyether ester polyols are those comprising the polycondensation products of: b1.1) one or more dicarboxylic acids which contain up to 12 carbon atoms and/or their derivatives; b1.2) one or more polyether polyols components that are selected from the group consisting of (i) one or more polyether polyols with a number average molecular weight of 1,000 g/mole to 8,000 g/mole and an ethylene oxide content of 10 to 40 wt. %, and (ii) one or more ether based polymer polyols with OH numbers of 10 to 149 and mean functionalities of 1.7 to 4, and which contain 1 to 50 wt. % solids, based on the total weight of the polymer polyols; b1.3) one or more polyols with a number average molecular weight of 62 to 750 g/mole, a number average functionality of 2 to 8 and which contain at least two terminal OH groups per molecule; and, optionally, b1.4) one or more ester-based polymer polyols having OH numbers of 10 to 149 and average functionalities of 1.7 to 4, and which contain 1 to 50 wt. % of solids, based on the total weight of polymer polyol.

Suitable organic dicarboxylic acids to be used as component b1.1) for preparing the polyether ester polyol component include those dicarboxylic acids with up to 12 carbon atoms. Preferred organic dicarboxylic acids are those aliphatic dicarboxylic acids with 4 to 6 carbon atoms, which may be used either individually or as a mixture. Suberic acid, azelaic acid, decanedicarboxylic acid, maleic acid, malonic acid, phthalic acid, pimelic acid and sebacic acid are disclosed as suitable, but non-limiting examples. Fumaric acid and succinic acid are more preferred, and glutaric acid and adipic acid are most preferred. Suitable derivatives of these acids, include, by way of example, the corresponding anhydrides as well as the corresponding esters and half-esters with low molecular weight, monohydric alcohols with 1 to 4 carbon atoms.

Suitable compounds to be used as component b1.2) for the production of the polyether ester polyols b1), are the polyether polyols b1.2 (i) that are obtained by alkoxylation of suitable starter molecules, and preferably polyhydric alcohols. These suitable starter molecules are at least difunctional, but may optionally also contain proportions of higher functional, and in particular trifunctional, starter molecules. The alkoxylation is normally carried out in two steps. First, an alkoxylation is carried out in the presence of basic catalysts or double metal cyanide catalysts, preferably with propylene oxide or, less preferably, with 1,2-butylene oxide or, even less preferably, with 2,3-butylene oxide, and this is followed by ethoxylation of the propoxylation product with ethylene oxide. The proportion of ethylene oxide in the polyether polyol is 10 wt. % to 40 wt. %, preferably 15 wt. % to 35 wt. %, and more preferably 18 wt. % to 32 wt. %.

In addition, part or all of component b1.2), there may be used b1.2) (ii) the ether-based polymer polyols with OH numbers of 10 to 149 and mean functionalities of 1.7 to 4. These polymer polyols typically contain 1 to 50 wt. % of solids, referred to the total weight of polymer polyol.

Suitable compounds to be used as component b1.3) for preparing the polyether ester polyols b1) of the invention, are those polyols having a number average functionality of 2 to 8, and preferably diols, and which preferably contain at least two primary OH groups, and which have number average molecular weights of 62 g/mole to 750 g/mole, preferably 62 g/mole to 400 g/mole, more preferably 62 g/mole to 200 g/mole. The following may be mentioned by way of example: 1,3-propanediol, 1,5-pentenediol, 1,5-pentanediol, neopentyl glycol, 1,6-hexanediol, 1,7-heptanediol, octanediol-1,8,1,10-decanediol, 2-methyl-1,3-propanediol, 2,2-dimethyl-1,3-propanediol, 3-methyl-1,5-pentanediol; 2-butyl-2-ethyl-1,3-propanediol, 2-butene-1,4-diol and 2-butyne-1,4-diol, triethylene glycol, tetraethylene glycol, dibutylene glycol, tributylene glycol, tetrabutylene glycol, dihexylene glycol, trihexylene glycol, tetrahexylene glycol, oligomer mixtures of alkylene glycols and in particular 1,2-ethanediol, 1,4-butanediol and diethylene glycol.

In addition to the diols set forth above, it is also possible to use, either alone or in combination with the diols, polyols which have number average functionalities above 2 and up to 8, preferably 2.1 to 5, and more preferably 3 to 4. Such polyols include compounds such as, for example 1,1,1-trimethylolpropane, triethanolamine, glycerol, sorbitan and pentaerythritol, as well as polyethylene oxide polyols started on triols and/or tetraols which have mean molecular weights of 62 g/mole to 750 g/mole, preferably 62 g/mole to 400 g/mole, and more preferably 62 g/mole to 200 g/mole.

In accordance with the present invention, each member of the group of diols may be used either individually or in combination with other diols and/or polyols. The diols and polyols, i.e. component b1.3), may also be added subsequently to a polyester polyol, even if they are not thereby converted or at least not until the polycondensation equilibrium is reached in the esterification reaction. The relative quantitative use of polyols is restricted by the predetermined number average hydroxyl functionality of the polyether ester polyol, component b1).

Suitable compounds to be used as polymer polyols for component b1.4)(ii), component b2.1)(ii) and component b4)(ii) are polymer-modified polyols, and particularly graft polymer polyols based on polyesters or polyether esters. Suitable for use as the graft component are, in particular, those graft components based on styrene and/or acrylonitrile, which are produced by in situ polymerization of acrylonitrile, styrene, or preferably mixtures of styrene and acrylonitrile. Preferred mixtures of styrene and acrylonitrile include those, for example, with styrene and acrylonitrile in a weight ratio of 90:10 to 10:90, and more preferably 70:30 to 30:70. The polymer polyols may be present as polyol dispersions, which contain as dispersed phase, for example, polyureas (PHD), polyhydrazides, and polyurethanes containing bound tert.-amino groups. Typically, these contain amounts of 1 to 50 wt. %, preferably 1 to 45 wt. % of solids, based on the total weight of the polymer polyol.

The mixture b2) consists of b2.1) and b2.2). Component b2.1) comprises one or more polyester polyol components selected from the group consisting of (i) one or more polyester polyols with a number average molecular weight of 1,000 to 4,000 g/mole and a functionality of 1.7 to 4, and (ii) one or more ester-based polymer polyols with an OH number of 10 to 149 and mean functionalities of 1.7 to 4, preferably 1.8 to 3.5 and which contain 1 to 50 wt. % of solids, based on the total weight of the polymer polyol. Suitable ester-based polymer polyols for component b2.1)(ii) are as described above.

Suitable polyester polyols for component b2.1)(i) and component b4)(i) include compounds which, for example, may be produced from organic dicarboxylic acids with 2 to 12 carbon atoms, preferably aliphatic dicarboxylic acids with 4 to 6 carbon atoms, and polyhydric alcohols, preferably diols with 2 to 12 carbon atoms, and more preferably 2 to 6 carbon atoms. Suitable dicarboxylic acids include, for example, succinic acid, malonic acid, glutaric acid, adipic acid, suberic acid, azelaic acid, sebacic acid, decanedicarboxylic acid, maleic acid, fumaric acid, phthalic acid, isophthalic acid and terephthalic acid. The dicarboxylic acids may, in this connection, be used individually as well as in the form of mixtures. Instead of the free dicarboxylic acids as described above, the corresponding dicarboxylic acid derivatives, such as e.g. dicarboxylic acid monoesters and/or diesters of alcohols with 1 to 4 carbon atoms or dicarboxylic acid anhydrides, may also be employed in the preparation of these polyester polyols. Dicarboxylic acid mixtures of succinic acid, glutaric acid and adipic acid are preferably used in quantitative ratios of, for example, 20 to 35 parts by weight of succinic acid, 35 to 50 parts by weight of glutaric acid, and 20 to 32 parts by weight of adipic acid, with the sum of the parts by weight of succinic acid, glutaric acid and adipic acid totalling 100 parts by weight. It is particularly preferred to use mixtures of dicarboxylic acids which contain adipic acid. Examples of suitable dillydric and polyhydric alcohols include ethanediol, diethylene glycol, 1,2-propanediol and 1,3-propanediol, dipropylene glycol, methylpropanediol-1,3,1,4-butanediol, 1,5-pentanediol, 1,6-hexanediol, neopentyl glycol, 1,10-decanediol, glycerol, trimethylolpropane and pentaerythritol. It is preferred to use 1,2-ethanediol, diethylene glycol, 1,4-butanediol, 1,6-hexanediol, glycerol, trimethylolpropane, or mixtures of at least two of the aforementioned diols. In particular, mixtures of two or more of ethanediol, diethylene glycol, 1,4-butanediol and 1,6-hexanediol, glycerol and/or trimethylolpropane are particularly preferred. Furthermore, compounds which may also be used include polyester polyols of lactones, e.g. α-caprolactone or hydroxycarboxylic acids, e.g. o-hydroxycaproic acid and hydroxyacetic acid. Also as suitable polyester polyols, there may furthermore be mentioned the polycarbonates containing hydroxyl groups.

It is preferred that these polyester polyols have a number average molecular weight of 1,000 to 4,000 g/mole, and a functionality of 1.7 to 4, preferably 1.8 to 3.5.

Suitable as polymer polyols in b2.1)(ii) are the ester based polymer-modified polyols that have already also been mentioned above as being suitable for component b 1.4).

In accordance with the present invention, b2) additionally comprises b2.2) from 5 to 48 wt. % of one or more polyether polyol components. These polyether polyols are selected from the group consisting of (i) one or more polyether polyols containing ethylene oxide groups and having a number average molecular weight of 900 to 18,000 g/mole, a functionality of 1.7 to 4, and an ethylene oxide content of 10 to 40 wt. %, and (ii) one or more ether-based polymer polyols having an OH number of 10 to 149, a mean functionality of 1.7 to 4, and which contain from 1 to 50 wt. % of solids, based on the total weight of polymer polyol.

Component b3) of the invention comprises one or more polyether polyol components having a number average hydroxyl functionality of 2.02 to 2.95. Suitable polyether polyols are those selected from the group consisting of b3.1) at least one polyether diol with an hydroxyl number of 10 to 115 and that is produced by propoxylation of a difunctional starter, with subsequent ethoxylation of the propoxylation product, while maintaining a weight ratio of propylene oxide to ethylene oxide of 60:40 to 85:15, and b3.2) at least one polyether triol which optionally contains solids based on styrene/acrylonitrile copolymers, polyureas or polyhydrazocarbonamides in an amount of up to 20 wt. %, based on the total weight of component b3), and in which the polyether triol has a hydroxyl number of 12 to 56, and is produced by propoxylation of a trifunctional starter with subsequent ethoxylation, while maintaining a weight ratio of propylene oxide to ethylene oxide of 60:40 to 85:15.

With regard to the component b2.2)(i), the component b3.1), and the component b3.2) when it (component b3.2)) does not contain solids, suitable polyether polyols used include those which are obtained by alkoxylation of suitable starter molecules, preferably polyhydric alcohols. The starter molecules are at least difunctional, but may, however, optionally also contain proportions of higher functional, in particular trifunctional, starter molecules. The alkoxylation is normally carried out in two steps. First of all, alkoxylation is carried out in the presence of basic catalysts or double metal cyanide catalysts, preferably with propylene oxide or, less preferably, with 1,2-butylene oxide or, even less preferably, with 2,3-butylene oxide, and then followed by ethoxylation with ethylene oxide. The proportion of ethylene oxide in the polyether polyol is 10 wt. % to 40 wt. %, preferably 15 wt. % to 35 wt. %, and more preferably 18 wt. % to 32 wt. %.

The ether-based polymer polyols used in component b2.2), specifically as component b2.2)(ii) and as component b3.2) a polyether triol which contains solids are preferably polymer-modified polyols, and in particular graft polymer polyols based on polyethers. Suitable grafting components are, in particular, those based on styrene and/or acrylonitrile, which are produced by in situ polymerisation of acrylonitrile, styrene, or preferably mixtures of styrene and acrylonitrile.

Preferably, mixtures of styrene and acrylonitrile include those mixtures containing styrene and acrylonitrile present, for example, in a weight ratio of 90:10 to 10:90, and more preferably in a weight ratio of 70:30 to 30:70. The polymer polyols may be present as polyol dispersions, which contain as dispersed phase, for example, polyureas (PHD), polyhydrazides, and polyurethanes containing bound tert.-amino groups. These polymer modified polyols normally contain amounts of 1 to 50 wt. %, and preferably 1 to 45 wt. % of solids, based on the total weight of the polymer polyol.

Chain extenders and/or crosslinking agents are used as component c) in accordance with the present invention.

Such chain extenders/crosslinking agents are used to modify the mechanical properties, and in particular, the hardness of the molded part. Diols with primary OH groups and number average molecular weights of below 750 g/mole, preferably 62 g/mole to 400 g/mole, and more preferably 62 g/mole to 200 g/mole, are preferably used as component c). The following compounds may be mentioned by way of example: 1,3-propanediol, 1,5-pentenediol, 1,5-pentanediol, neopentyl glycol, 1,6-hexanediol, 1,7-heptanediol, octanediol-1,8,1,10-decanediol, 2-methyl-1,3-propanediol, 2,2-dimethyl-1,3-propanediol, 3-methyl-1,5-pentanediol, 2-butyl-2-ethyl-1,3-propanediol, 2-butene-1,4-diol and 2-butyne-1,4-diol, triethylene glycol, tetraethylene glycol, dibutylene glycol, tributylene glycol, tetrabutylene glycol, dihexylene glycol, trihexylene glycol, tetrahexylene glycol, oligomer mixtures of alkylene glycols, and in particular, mixtures of 1,2-ethanediol, 1,4-butanediol and diethylene glycol.

In addition to the above mentioned diols, polyols with number average functionalities of above 2 and up to 8, preferably 2.1 to 5, particularly preferably 3 to 4, may also be used in conjunction, e.g. 1,1,1-trimethylolpropane, triethanolamine, glycerol, sorbitan and pentaerythritol, as well as polyethylene oxide polyols started on triols or tetraols, which have mean molecular weights of below 750 g/mole, preferably 62 g/mole to 400 g/mole, and more preferably 62 g/mole to 200 g/mole.

Each member of the group of diols may be used either individually or in combination with other diols and polyols.

Crosslinking agents include, in addition to the aforementioned polyols, compounds such as, e.g. triols, tetraols, oligomeric polyalkylene polyols, and also aromatic and aliphatic amines and diamines with a functionality of 2 to 8, preferably 2 to 4, which normally have molecular weights of less than 750 g/mole, preferably 62 to 400 g/mole and more preferably 62 to 200 g/mole.

The component c) is preferably present in an amount of 5 to 25 wt. %, based on the combined weight of the components b) and c).

The blowing agent component d) comprises a mixture of component d1), component d2) and component d3). Component d1) is at least one blowing agent selected from the group consisting of nitrogen, air and/or carbon dioxide. In this connection, it is advantageous if the gases used as blowing agent component d1) are added above atmospheric pressure to the components a) and/or b). It is preferred to add these gases to components a) and/or b) at a pressure between 1 and 11 bar absolute.

Suitable compounds to be used as blowing agent component d2) include, for example, those physical blowing agents that vaporise under the influence of the exothermic polyaddition reaction, and preferably have a boiling point under normal pressure in the range from −30° to 75° C. Other suitable blowing agents for component d2) include chemical blowing agents, such as, for example, water and carbamates. The following compounds are disclosed by way of example, but are not intended to be limiting: acetone, ethyl acetate, halogen-substituted alkanes, perhalogenated alkanes such as R134a, R141b, R365mfc, R245fa, butane, pentane, cyclopentane, hexane, cyclohexane, heptane or diethyl ether. A blowing effect may also be achieved by adding compounds that decompose at temperatures above room temperature with the release of gases, for example nitrogen and/or carbon dioxide, by using compounds such as azo compounds, e.g. azodicarbonamide or azoisobutyronitrile, or salts such as ammonium bicarbonate, ammonium carbamate or ammonium salts of organic carboxylic acids, e.g. monoammonium salts of malonic acid, boric acid, formic acid or acetic acid.

Further examples of blowing agents as well as details of the use of blowing agents, are described in R. Vieweg, A. Höchtlen (Eds.): “Kunstoff-Handbuch”, Vol. VII, Carl-Hanser-Verlag, Munich, 3rd Edition, 1993, pp. 115 to 118, 710 to 715.

Suitable to be used as blowing agent component d3) include, for example, the preferred hollow microspheres with enclosed blowing gases or liquids with boiling points between −30° and +75° C. and a thermoplastically deformable skin, such as are described in, for example, U.S. Pat. No. 5,260,343, the disclosure of which is hereby incorporated by reference, and are produced and marketed for example by AKZO NOBEL.

If necessary, one or more emulsifier, i.e. component e), may preferably also be added, and in particular, when component d2) of the blowing agent comprises water.

Suitable for use as component e), are the anionic, cationic, amphoteric or non-ionic (neutral) emulsifiers.

For the production of the molded parts, there may optionally be used further additives and/or auxiliary substances as component f). The following are mentioned by way of example, but are non-limiting examples: surface-active additives such as foam stabilizers, cell regulators, flameproofing agents, nucleating agents, antioxidants, stabilizers, lubricants and mold release agents, fillers, dyes, dispersing aids and pigments. Reaction inhibitors, flameproofing agents, antistatics, stabilizers against ageing and weathering influences, plasticizers, viscosity regulators and substances having a fungistatic and bacteriostatic action may also be used.

Component g) to be used in accordance with the invention comprises one or more known polyurethane catalysts. Suitable known catalysts include, for example, amine catalysts such as, for example, tertiary amines such as triethylamine, tributylamine, N-methylmorpholine, N-ethylmorpholine, N,N,N′,N′-tetramethyl-ethylenediamine, pentamethyldiethylene-triamine and higher homologues, 1,4-diaza-bicyclo-[2.2.2]-octane, N-methyl-N′-dimethylaminoethyl-piperazine, bis-(dimethylaminoalkyl)-piperazine, N,N-dimethylbenzylamine, N,N-dimethylcyclohexylamine, N,N-diethylbenzylamine, bis-(N,N-diethylaminoethyl)adipate, N,N,N′,N′-tetramethyl-1,3-butanediamine, N,N-dimethyl-β-phenylethylamine, bis-(dimethylaminopropyl)-urea, bis-(dimethylaminopropyl)-amine, 1,2-dimethylimidazole, 2-methylimidazole, diazabicyclo-undecene, monocyclic and bicyclic amidines, bis-(dialkylamino)-alkyl ethers such as, for example, bis(dimethylaminoethyl) ether, as well as tertiary amines containing amide groups (preferably formamide groups). Other suitable catalysts also include Mannich bases of secondary amines, such as dimethylamine, and aldehydes, preferably formaldehyde, or ketones such as acetone, methyl ethyl ketone or cyclohexanone, and phenols such as phenol, N-nonylphenol or bisphenol A. Tertiary amines containing hydrogen atoms that are Zerewittinoff-active with respect to isocyanate groups may also be used as the catalyst such as, for example, triethanolamine, triisopropanolamine, N-methyldiethanolamine, N-ethyldiethanolamine, N,N-dimethylethanolamine, and their reaction products with alkylene oxides such as propylene oxide and/or ethylene oxide, as well as secondary and/or tertiary amines. Also suitable to be used as catalysts, are the sila-amines with carbon-silicon bonds, e.g. 2,2,4-trimethyl-2-silamorpholine and 1,3-diethylaminoethyltetramethyl disiloxane. In addition, there may also be used nitrogen-containing bases such as tetraalkylammonium hydroxides, and also hexahydrotriazines. The reaction between NCO groups and Zerewittinoff-active hydrogen atoms is also greatly accelerated by lactams and azalactams. According to the invention, organometallic compounds of tin, titanium, bismuth, and in particular organotin compounds, may also be co-used as additional catalysts.

Suitable organotin compounds, in addition to sulfur-containing compounds such as di-n-octyl tin mercaptide, are also preferably tin(II) salts of carboxylic acids, Such as tin(II) acetate, tin(II) octoate, tin(II) ethylhexoate, tin(II) laurate and tin(II) compounds, e.g. dibutyltin oxide, dibutyltin dichloride, dibutyltin diacetate, dibutyltin dilaurate, dibutyltin maleate or dioctyltin diacetate.

The molded parts of the present invention can be accurately produced from the components a) to f) in the mold and without so-called core burning.

These molded parts are preferably employed as particularly light shoe soles, which are especially suitable for bath slippers, beach sandals and house shoes. They may also be used as plates and/or component parts of shoes.

The invention will be illustrated in more detail with the aid of the following examples.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

The examples were carried out on screw-type casting machines from the Desma company. In this connection either a 2-component or 3-component metering procedure was adopted. A 2-component metering procedure was used for Example 9 and a 3-component metering procedure was used for Examples 1-8.

In the 2-component metering procedure, used for Example 9 component A comprised: the polyol mixture; and component B comprised: the isocyanate component.

In the 3-component metering procedure used for Examples 1-8, component A comprised: the polyol mixture; component B comprised: the isocyanate component; and component C; comprised a batch consisting of a part of component A plus hollow microspheres.

The product temperatures were matched to the raw material base. Polyester base: 40° to 45° C.; polyether base: 30° to 35° C. The mold temperatures were maintained between 53° and 60° C.

The CO₂ was added to the polyol component or to the polyol component and the isocyanate component by means of a gassing device from the Desma company.

The following raw materials were used in these examples:

| | |
|---|---|
| Polyisocyanate 1: | Desmodur ® PF from Bayer MaterialScience AG |
| Polyisocyanate 2: | Desmodur ® VP PU 0926 from Bayer MaterialScience |
| | AG |
| Polyol 1: | EG-BD-(polypropylene/ethylene oxide) adipate, OH |
| | No. 55 (a polyether ester polyol) |
| Polyol 2: | EG-BD-polyadipate; OH No. 55 (a polyester polyol) |
| Polyol 3: | PO-EO (80/20) polyol, OH No. 28 (terminal EO), |
| | molecular weight of 4,000 |
| Polyol 4: | PO-EO (85:15) polyol, TMP-started, OH No. 27 and |
| | having a molecular weight of 6,000 (a polyether |
| | polyol) |
| Emulsifier 1: | diphenyl polyglycol ether, OH number of 80 and |
| | molecular weight of 450, an emulsifier from Bayer |
| | MaterialScience AG |
| Emulsifier 2: | diisobutyl phthalate, a plasticiser from Bayer |
| | MaterialScience AG |
| Emulsifier 3: | Adimoll DO from Bayer MaterialScience AG |
| Stabilizer 1: | OS22 from Bayer MaterialScience AG |
| Stabilizer 2: | DC 190 from Air Products |
| Catalyst 1: | Dabco ® 1027 from Air Products |
| Catalyst 2: | Dabco ® BL-11 from Air Products |
| Catalyst 3: | UL 1 from Crompton |
| Dabco ® in EG: | 80 wt. % Dabco ® dissolved in 20 wt. % ethylene |
| | glycol (catalyst) |
| Tela: | triethanolamine (a crosslinking agent) |
| Ethanediol: | a chain extender |

Polyester Base Examples:

| | | Ex. 1 | Ex. 2 | Ex. 3 | Ex. 4 | Ex. 5 |
|---|---|---|---|---|---|---|
| Polyol 1 | pts. by wt. | — | — | — | — | 74.456 |
| Polyol 2 | pts. by wt. | 65.504 | 65.504 | 65.504 | 74.546 | — |
| Polyol 3 | pts. by wt. | 9.042 | 9.042 | 9.042 | — | — |
| Ethanediol | pts. by wt. | 13.111 | 13.111 | 13.111 | 13.111 | 13.111 |
| Tela | pts. by wt. | 0.407 | 0.407 | 0.407 | 0.407 | 0.407 |
| Dabco ® in EG | pts. by wt. | 0.678 | 0.678 | 0.678 | 0.678 | 0.678 |
| Catalyst 2 | pts. by wt. | 0.090 | 0.090 | 0.090 | 0.090 | 0.090 |
| Catalyst 1 | pts. by wt. | 0.452 | 0.452 | 0.452 | 0.452 | 0.452 |
| Emulsifier 3 | pts. by wt. | 4.973 | 4.973 | 4.973 | 4.973 | 4.973 |
| Water | pts. by wt. | 0.452 | 0.452 | 0.452 | 0.452 | 0.452 |
| Stabilizer 1 | pts. by wt. | 0.045 | 0.045 | 0.045 | 0.045 | 0.045 |
| Emulsifier 2 | pts. by wt. | 0.823 | 0.823 | 0.823 | 0.823 | 0.823 |
| Emulsifier 1 | pts. by wt. | 0.353 | 0.353 | 0.353 | 0.454 | 0.353 |
| Expancel DUX 053 | pts. by wt. | 3.165 | 3.165 | 3.165 | 3.165 | 3.165 |
| Dissolved CO₂ | wt. % | 0.9 | 0.75 | 0.6 | 0.75 | 0.75 |
| Polyisocyanate 2 | pts. by wt. | 124 | 124 | 124 | 126 | 126 |
| Density of free rise foam | kg/m³ | 143 | 157 | 167 | 176 | 142 |
| Average density of the molded | kg/m³ | 260 | 280 | 300 | 320 | 250 |
| part | | | | | | |

Polyether Base Examples:

| | | Ex. 6 | Ex. 7 | Ex. 8 | Ex. 9 |
|---|---|---|---|---|---|
| Polyol 3 | pts. by | 37.91 | 37.91 | 37.91 | 76.63 |
| | wt. | | | | |
| Polyol 4 | pts. by | 40.00 | 40.00 | 40.00 | 5.00 |
| | wt. | | | | |
| Ethanediol | pts. by | 10.00 | 10.00 | 10.00 | 10.00 |
| | wt. | | | | |
| Dabco ® in EG | pts. by | 0.33 | 0.33 | 0.33 | 0.33 |
| | wt. | | | | |
| Emulsifier 3 | pts. by | 5.500 | 5.500 | 5.500 | 5.50 |
| | wt. | | | | |
| Catalyst 3 | pts. by | 0.02 | 0.02 | 0.02 | 0.02 |
| | wt. | | | | |
| Catalyst 2 | pts. by | 0.10 | 0.10 | 0.10 | 0.02 |
| | wt. | | | | |
| Tela | pts. by | 0.00 | 0.00 | 0.00 | 0.0 |
| | wt. | | | | |
| Stabilizer 2 | pts. by | 0.40 | 0.40 | 0.40 | 0.4 |
| | wt. | | | | |
| Expancel DUX 053 | pts. by | 3.500 | 3.500 | 3.500 | 0.0 |
| | wt. | | | | |
| Water | wt. % | 0.35 | 0.35 | 0.35 | 0.35 |
| Dissolved CO₂ | wt. % | 0.90 | 0.75 | 0.60 | 0.75 |
| Polyisocyanate ® 1 | pts. by | 74 | 74 | 74 | 74 |
| | wt. | | | | |
| Density of free rise | kg/m³ | 159 | 170 | 183 | 225 |
| foam | | | | | |
| Average density of | kg/m³ | 290 | 310 | 330 | 435 |
| the molded part | | | | | |
| density | | | | | |

The above examples, i.e. Examples 1-8, showed that in all cases there was a thicker skin formation (>0.5 mm) and a thicker and more highly compacted zone on the lower side of the mold than on the upper side of the mold (having a skin about 0.2 mm thick). In Comparison Example 9, the product has a skin of about only 0.2 mm on the lower side as well as on the upper side of the mold.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A flexible molded part of expanded polyurethane in which the molded part has an average density of <350 kg/m³, and an unilaterally compacted edge zone with a thickness of 0.5 mm to 3 mm, in which the average density of the edge zone is >650 kg/m³, and contains enclosed hollow microspheres, in which the shrinkage of the molded part is <1.5% (according to DIN ISO 02769), and comprises the reaction product of:
a) one or more organic isocyanates containing from 2 to 4 NCO groups per molecule and having an NCO group content of 6 to 49 wt. %;
b) a polyol component selected from the group consisting of:
b1) one or more polyether ester polyols with a number average molecular weight of 800 g/mole to 6,000 g/mole, an average functionality of 1.7 to 4, and a weight ratio of ether groups to ester groups of the polyether ester polyol of 5:95 to 48:52, wherein the polyether ester polyols are prepared by polycondensation of
b1.1) one or more dicarboxylic acids with up to 12 carbon atoms and/or their derivatives,
b1.2) one or more polyether polyol components selected from the group consisting of:
(i) one or more polyether polyols with a number average molecular weight of 1,000 g/mole to 8,000 g/mole, an ethylene oxide content of 10 to 40 wt. %, and
(ii) one or more ether-based polymer polyols with OH numbers of 10 to 149 and average functionalities of 1.7 to 4, and which contain 1 to 50 wt. % of solids, based on the total weight of the polymer polyol,
b1.3) one or more polyols with a number average molecular weight of 62 to 750 g/mole, an average functionality of 2 to 8, and with at least two terminal OH groups per molecule, and, optionally,
b1.4) one or more ester-based polymer polyols that have OH numbers of 10 to 149 and average functionalities of 1.7 to 4, and which contain 1 to 50 wt. % of solids, based on the total weight of the polymer polyol;
b2) a mixture of
b2.1) from 52 to 95 wt. %, based on 100 wt. % of b2), of one or more polyester polyol components selected from the group consisting of:
(i) one or more polyester polyols with a number average molecular weight of 1,000 to 4,000 g/mole and an average functionality of 1.7 to 4, and
(ii) one or more ester-based polymer polyols with an OH number of 10 to 149 and an average functionality of 1.7 to 4, and which contain 1 to 50 wt. %, of solids, based on the total weight of polymer polyol, and
b2.2) from 5 to 48 wt. %, based on 100 wt. % of b2), of one or more polyether polyol components selected from the group consisting of:
(i) one or more polyether polyols containing ethylene oxide groups, and having a number average molecular weight of 900 to 18,000 g/mole, an average functionality of 1.7 to 4, and an ethylene oxide content of 10 to 40 wt. %, and
(ii) one or more ether-based polymer polyols that have an OH number of 10 to 149 and an average functionality of 1.7 to 4, and that contain 1 to 50 wt. %, of solids, based on the total weight of polymer polyol,
b3) one or more polyether polyol components with an average hydroxyl functionality of 2.02 to 2.95, and being selected from the group consisting of:
b3.1) at least one polyether diol with an hydroxyl number of 10 to 115 and which comprises the reaction product prepared by propoxylation of a difunctional starter, with subsequent ethoxylation of the propoxylation product, while maintaining a weight ratio of propylene oxide to ethylene oxide of 60:40 to 85:15, and
b3.2) at least one polyether triol which optionally contains solids based on styrene/acrylonitrile copolymers, polyureas or polyhydrazocarbonamides in an amount of up to 20 wt. %, based on the total weight of component b3), wherein said polyether triol has an hydroxyl number of 12 to 56, and comprises the reaction product prepared by propoxylation of a trifunctional starter, with subsequent ethoxylation, while maintaining a weight ratio of propylene oxide to ethylene oxide of 60:40 to 85:15,
b4) one or more polyester polyol components selected from the group consisting of:
(i) one or more polyester polyols with a number average molecular weight of 1,000 to 4,000 g/mole and an average functionality of 1.7 to 4, and
(ii) one or more ester-based polymer polyols with an OH number of 10 to 149 and an average functionality of 1.7 to 4, and that contain from 1 to 50 wt. % of solids, based on the total weight of component b4),
b5) a mixture of b1) and b2),
b6) a mixture of b1) and b3) and
b7) a mixture of b1) and b4);
c) from 5 to 25 wt. %, based on the combined weight of components b) and c), of one or more crosslinking agents and/or chain extenders,
d) a blowing agent comprising:
d1) at least one blowing agent selected from the group consisting of nitrogen, air and/or carbon dioxide,
d2) at least one component selected from the group consisting of chemical blowing agents and physical blowing agents with boiling points in the range from −30° C. to 75° C., and
d3) one or more physically expanding hollow microspheres, and, optionally, one or more of
e) one or more emulsifiers,
f) one or more additives and/or auxiliary substances,
g) one or more catalysts,
wherein the Isocyanate Index is from 95 to 115.

2. The molded part of claim 1, wherein b1) said one or more polyether ester polyols have a number average molecular weight of 1,200 to 4,000 g/mole, an average functionality of 1.8 to 2.7 and a weight ratio of ether groups to ester groups of the polyether ester polyol of 8:92 to 30:70, and wherein the polyether ester polyols are prepared by polycondensation of:
b1.1) one or more dicarboxylic acids with up to 12 carbon atoms and/or their derivatives,
b1.2) one or more polyether polyol components selected from the group consisting of:
(i) one or more polyether polyols with a number average molecular weight of 1,500 g/mole to 6,000 g/mole, an ethylene oxide content of 15 to 35 wt. %, and
(ii) one or more ether-based polymer polyols with OH numbers of 10 to 149 and average functionalities of 1.8 to 3.5, and which contain 1 to 45 wt. % of solids, based on the total weight of the polymer polyol,
b1.3) one or more polyols with a number average molecular weight of 62 to 400 g/mole, an average functionality of 2 to 8, and with at least two terminal OH groups per molecule, and, optionally,
b1.4) one or more ester-based polymer polyols that have OH numbers of 10 to 149 and average functionalities of 1.8 to 3.5, and which contain 1 to 45 wt. % of solids, based on the total weight of the polymer polyol.

3. The molded part of claim 1, wherein b2) comprises a mixture of:
b2.1) from 70 to 92 wt. %, based on 100 wt. % of b2), of one or more polyester polyol components selected from the group consisting of:
(i) one or more polyester polyols with a number average molecular weight of 1,000 to 4,000 g/mole and an average functionality of 1.7 to 4, and
(ii) one or more ester-based polymer polyols with an OH number of 10 to 149 and an average functionality of 1.8 to 3.5, and which contain 1 to 45 wt. %, of solids, based on the total weight of polymer polyol, and
b2.2) from 8 to 30 wt. %, based on 100 wt. % of b2), of one or more polyether polyol components selected from the group consisting of:
(i) one or more polyether polyols containing ethylene oxide groups, and having a number average molecular weight of 2,000 to 8,000 g/mole, an average functionality of 1.8 to 2.7, and an ethylene oxide content of 15 to 35 wt. %, and
(ii) one or more ether-based polymer polyols that have an OH number of 10 to 149 and an average functionality of 1.8 to 3.5, and that contain 1 to 45 wt. %, of solids, based on the total weight of polymer polyol.

4. The molded part of claim 1, wherein b4) one or more polyester polyol components selected from the group consisting of:
(i) one or more polyester polyols with a number average molecular weight of 1,000 to 4,000 g/mole and an average functionality of 1.7 to 4, and
(ii) one or more ester-based polymer polyols with an OH number of 10 to 149 and an average functionality of 1.8 to 3.5, and that contain from 1 to 45 wt. % of solids, based on the total weight of component b4).

5. The molded part of claim 1, in which the density of the resultant part is <300 kg/m3, and the part has a unilaterally compacted edge zone with a thickness of 0.7 to 2.5 mm.

6. A process for the production of a flexible molded part of expanded polyurethane, in which the molded part has a density of <350 kg/m³, and has an unilaterally compacted edge zone with a thickness of 0.5 mm to 3 mm, in which the average density of the edge zone is >650 kg/m³, and contains enclosed hollow microspheres, and in which the shrinkage of the molded part is <1.5% (according to DIN ISO 02769), and comprises
A) reacting component a) with component b) and component c), with the addition of the components d), and, optionally, e) and/or f), and, optionally, in the presence of component g) in a mold, at an Isocyanate Index of 95 to 115,
B) removing the resultant molded part from the mold,
wherein
component a) comprises one or more organic isocyanates containing from 2 to NCO groups per molecule and having an NCO group content of 6 to 49 wt. %;
component b) comprises a polyol component selected from the group consisting of:
b1) one or more polyether ester polyols with a number average molecular weight of 800 g/mole to 6,000 g/mole, an average functionality of 1.7 to 4, and a weight ratio of ether groups to ester groups of the polyether ester polyol of 5:95 to 48:52, wherein the polyether ester polyols are prepared by polycondensation of
b1.1) one or more dicarboxylic acids with up to 12 carbon atoms and/or their derivatives,
b1.2) one or more polyether polyol components selected from the group consisting of:
(i) one or more polyether polyols with a number average molecular weight of 1,000 g/mole to 8,000 g/mole, an ethylene oxide content of 10 to 40 wt. %, and
(ii) one or more ether-based polymer polyols with OH numbers of 10 to 149 and average functionalities of 1.7 to 4, and which contain 1 to 50 wt. % of solids, based on the total weight of the polymer polyol,
b1.3) one or more polyols with a number average molecular weight of 62 to 750 g/mole, an average functionality of 2 to 8, and with at least two terminal OH groups per molecule, and, optionally,
b1.4) one or more ester-based polymer polyols that have OH numbers of 10 to 149 and average functionalities of 1.7 to 4, and which contain 1 to 50 wt. % of solids, based on the total weight of the polymer polyol;
b2) a mixture of
b2.1) from 52 to 95 wt. %, based on 100 wt. % of b2), of one or more polyester polyol components selected from the group consisting of:
(i) one or more polyester polyols with a number average molecular weight of 1,000 to 4,000 g/mole and an average functionality of 1.7 to 4, and
(ii) one or more ester-based polymer polyols with an OH number of 10 to 149 and an average functionality of 1.7 to 4, and which contain 1 to 50 wt. %, of solids, based on the total weight of polymer polyol, and
b2.2) from 5 to 48 wt. %, based on 100 wt. % of b2), of one or more polyether polyol components selected from the group consisting of:
(i) one or more polyether polyols containing ethylene oxide groups, and having a number average molecular weight of 900 to 18,000 g/mole, an average functionality of 1.7 to 4, and an ethylene oxide content of 10 to 40 wt. %, and
(ii) one or more ether-based polymer polyols that have an OH number of 10 to 149 and an average functionality of 1.7 to 4, and that contain 1 to 50 wt. %, of solids, based on the total weight of polymer polyol,
b3) one or more polyether polyol components with a number average hydroxyl functionality of 2.02 to 2.95, and being selected from the group consisting of:
b3.1) at least one polyether diol with an hydroxyl number of 10 to 115 and which comprises the reaction product prepared by propoxylation of a difunctional starter, with subsequent ethoxylation of the propoxylation product, while maintaining a weight ratio of propylene oxide to ethylene oxide of 60:40 to 85:15, and
b3.2) at least one polyether triol which optionally contains solids based on styrene/acrylonitrile copolymers, polyureas or polyhydrazocarbonamides in an amount of up to 20 wt. %, based on the total weight of component b3), wherein said polyether triol has an hydroxyl number of 12 to 56, and comprises the reaction product prepared by propoxylation of a trifunctional starter, with subsequent ethoxylation, while maintaining a weight ratio of propylene oxide to ethylene oxide of 60:40 to 85:15,
b4) one or more polyester polyol components selected from the group consisting of:
(i) one or more polyester polyols with a number average molecular weight of 1,000 to 4,000 g/mole and an average functionality of 1.7 to 4, and
(ii) one or more ester-based polymer polyols with an OH number of 10 to 149 and an average functionality of 1.7 to 4, and that contain from 1 to 50 wt. % of solids, based on the total weight of component b4),
b5) a mixture of b1) and b2),
b6) a mixture of b1) and b3) and
b7) a mixture of b1) and b4);
component c) comprises from 5 to 25 wt. %, based on the combined weight of components b) and c), of one or more crosslinking agents and/or chain extenders,
component d) comprises a blowing agent comprising:
d1) at least one blowing agent selected from the group consisting of nitrogen, air and/or carbon dioxide,
d2) at least one component selected from the group consisting of chemical blowing agents and physical blowing agents with boiling points in the range from −30° C. to 75° C., and
d3) one or more physically expanding hollow microspheres, and, optionally, one or more of
component e) comprises one or more emulsifiers,
component f) comprises one or more additives and/or auxiliary substances,
component g) comprises one or more catalysts.

7. The process of claim 6, wherein b1) said one or more polyether ester polyols have a number average molecular weight of 1,200 to 4,000 g/mole, an average functionality of 1.8 to 2.7 and a weight ratio of ether groups to ester groups of the polyether ester polyol of 8:92 to 30:70, and wherein the polyether ester polyols are prepared by polycondensation of:
b1.1) one or more dicarboxylic acids with up to 12 carbon atoms and/or their derivatives,
b1.2) one or more polyether polyol components selected from the group consisting of:
(i) one or more polyether polyols with a number average molecular weight of 1,500 g/mole to 6,000 g/mole, an ethylene oxide content of 15 to 35 wt. %, and
(ii) one or more ether-based polymer polyols with OH numbers of 10 to 149 and average functionalities of 1.8 to 3.5, and which contain 1 to 45 wt. % of solids, based on the total weight of the polymer polyol,
b1.3) one or more polyols with a number average molecular weight of 62 to 400 g/mole, an average functionality of 2 to 8, and with at least two terminal OH groups per molecule, and, optionally,
b1.4) one or more ester-based polymer polyols that have OH numbers of 10 to 149 and average functionalities of 1.8 to 3.5, and which contain 1 to 45 wt. % of solids, based on the total weight of the polymer polyol.

8. The process of claim 6, wherein b2) comprises a mixture of:
b2.1) from 70 to 92 wt. %, based on 100 wt. % of b2), of one or more polyester polyol components selected from the group consisting of:
(i) one or more polyester polyols with an average molecular weight of 1,000 to 4,000 g/mole and a functionality of 1.7 to 4, and
(ii) one or more ester-based polymer polyols with an OH number of 10 to 149 and an average functionality of 1.8 to 3.5, and which contain 1 to 45 wt. %, of solids, based on the total weight of polymer polyol, and
b2.2) from 8 to 30 wt. %, based on 100 wt. % of b2), of one or more polyether polyol components selected from the group consisting of:
(i) one or more polyether polyols containing ethylene oxide groups, and having a number average molecular weight of 2,000 to 8,000 g/mole, an average functionality of 1.8 to 2.7, and an ethylene oxide content of 15 to 35 wt. %, and
(ii) one or more ether-based polymer polyols that have an OH number of 10 to 149 and an average functionality of 1.8 to 3.5, and that contain 1 to 45 wt. %, of solids, based on the total weight of polymer polyol.

9. The process of claim 6, wherein b4) one or more polyester polyol components selected from the group consisting of:
(i) one or more polyester polyols with a number average molecular weight of 1,000 to 4,000 g/mole and an average functionality of 1.7 to 4, and
(ii) one or more ester-based polymer polyols with an OH number of 10 to 149 and an average functionality of 1.8 to 3.5, and that contain from 1 to 45 wt. % of solids, based on the total weight of component b4).

10. The process of claim 6, in which the density of the resultant part is <300 kg/m3, and the part has a unilaterally compacted edge zone with a thickness of 0.7 to 2.5 mm.
